(19) United States
(12) Patent Application Publication
(10) Pub. No.: US 2003/0200099 A1
(43) Pub. Date: Oct. 23, 2003

(54) Method and system for providing imaging services to a digital order

(75) Inventors: Edward C. Mauro, Rochester, NY (US); Anthony M. Kelly, Webster, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/124,118

(22) Filed: Apr. 17, 2002

(51) Int. Cl. G06F 17/60

(52) U.S. Cl. 705/1

(57) ABSTRACT

The present invention relates to a system and method of offering imaging service to a customer in which an adhesive label with encoded information thereon is affixed to digital image storage medium such as a memory card, and the encoded information is entered into a master database. The encoded information on the adhesive label is linked to the information in the master database and includes a significant amount of photofinishing customization and billing information for the customer. In a preferred feature of the present invention, default information could include customer billing information as well as a preferred type of photofinishing service that is to be done on images provided from the memory card having the label affixed thereon. Thus, every time a customer places the memory card into a reader at a photofinishing station such as a kiosk, the encoded information would be read by the reader and linked to the master database. With this arrangement, all necessarily billing and customization information would be added to the order without any operator or customer intervention.

### FIELD OF THE INVENTION

The present invention relates to a method and system for offering imaging services to images in a customer's order, where the images are digital images stored in a removable digital storage medium such as, for example, a memory card, a compact flash card, a floppy disk, a secure digital media card (SD memory), a memory stick, a hard drive, an optical disk, etc.

### BACKGROUND OF THE INVENTION

There are known methods of associating information with a customer order, where the information includes, for example, instructions on providing photofinishing services to images submitted by the customer. For example, U.S. Pat. No. 6,201,931 discloses a system in which an identifier is printed on a film cassette. In this patent, the identifier is readable and provides information regarding the images on the specific roll of film provided in the cassette. A drawback with this arrangement is that since the identifier is associated with the cassette and thus, with the images in the cassette, the identifier will only be usable with the specific present images on the cassette, as opposed to both the present images and future images.

With the advent of digital imaging, digital cameras, removable digital storage mediums such as memory cards, and stand-alone imaging units such as kiosks, a system and method which facilitates a photofinishing fulfillment of digital orders is desirable. Presently, kiosks and other stand-alone units which require a customer to enter personal information, billing information, and information as to the type of photofinishing desired for the images on the digital image storage medium are available. For standard or basic orders, (i.e. 4×6 double prints), these systems tend to require a significant amount of customer interaction in that they require that the customer not only properly load images into the kiosk, but also require that the customer enter specific information as to the photofinishing process desired on the images and also enter billing information. This can be time consuming when the customer has to enter the same information for each order, especially when the majority of the customer's orders are the same (for example, the customer almost always orders 4×6 double prints).

Therefore, what is needed is a system and method that facilitates the photofinishing process and minimizes customer interaction with a kiosk or service provider by automatically and transparently assigning customer billing and customization data to a customer digital order. What is further needed is a system and method which does not require the alteration of file structures or the architecture/electronics of a digital image storage medium such as a memory card.

### SUMMARY OF THE INVENTION

The present invention provides for a system and method which facilitates the photofinishing process for digital images that originate from a removable digital image storage medium such as a memory card, a compact flash card, a floppy disk, a secure digital media card (SD memory), a memory stick, a hard drive, an optical disk, etc. More specifically, the present invention relates to a system and process which automatically and transparently assigns customer billing and customization data to a customer digital order that originates from a digital image storage medium such as a memory card.

The present invention further provides for an improved photofinishing process for digital orders which originate from a digital image storage medium, wherein a label encoded with information thereon is provided on the digital image storage medium. The encoded information includes information with respect to a desired or preferred photofinishing service, process or product which is to be performed on or associated with images that are loaded from the digital image storage medium, and further includes all the necessary customer billing and personal information. The advantage of the system and method of the present invention is that the encoded information is tied to a digital image storage medium that is reusable and accordingly, is applicable to all present and future images that are loaded from the digital image storage medium. More specifically, the encoded information in the present invention can be associated with the customer and the digital image storage medium and therefore, all images that originate from the specific digital image storage medium having a label with encoded information thereon would be processed in accordance with the encoded information.

The present invention provides for a method of offering imaging services to a customer which comprises the steps of providing a label having encoded information thereon to a customer, with the label being adapted to be affixed onto a removable digital image storage medium and the encoded information being associated with the customer; entering label information representative of the encoded information into a database to store the label information; reading the encoded information on the label when the customer places a removable digital images storage medium with the label affixed thereon into an imaging station having a reader, with the images on the digital image storage medium being loaded from the digital image storage medium to the imaging station; linking the encoded information on the label of the digital image storage medium with the stored label information in the database; and providing imaging services to images loaded to the imaging station from the digital image storage medium based on at least the linked stored label information in the database.

The present invention further relates to a method of offering photofinishing imaging services to a customer which comprises the steps of encoding customer information onto a least one adhesive label; entering label information representative of the encoded customer information into a database to store the label information; affixing the adhesive label onto a removable digital image storage medium and providing the digital image storage medium to a customer; reading the encoded customer information on the adhesive label when the customer submits the digital imaging storage medium with images thereon to a reader of an imaging station, with the encoded customer information being read by the reader as the images on the digital image storage medium are being loaded into the imaging station; linking the encoded customer information on the label of the digital image storage medium with the stored label information in the database; and providing image services for images on the digital image storage medium based on at least a linked stored label information in the database.

The present invention further relates to a system for offering imaging services which comprises an input section adapted to receive a removable digital image storage medium therein and permit a loading of images from the digital image storage medium; a reader adapted to read a label on the digital image storage medium, with the label having encoded information thereon and being affixed onto the digital image storage medium; a processor having a database which includes stored label information representative of the encoded information, with the processor being adapted to link the encoded information which is read by the reader from the label with the stored label information; and a photofinishing services output section adapted to provide imaging services to the images from the digital image storage medium based on at least the linked storage label information in the database.

The present invention further relates to a method of offering photofinishing imaging services to a customer which comprises the steps of: encoding customer information onto a digital image storage medium; entering further information representative of the encoded customer information into a database to store the further information; reading the encoded customer information on the digital image storage medium when the customer submits the digital image storage medium with images thereon to a reader of an imaging station; linking the encoded customer information on the digital image storage medium with the stored further information in the database; and providing imaging services for images on the digital image storage medium based on at least the linked stored further information in the database.

### BRIEF DESCRIPTION OF THE DRAWINGS

FIG. 1A schematically illustrates an example of a digital image storage medium having a label affixed thereon in accordance with the present invention;

FIG. 1B illustrates the label shown in FIG. 1A;

FIG. 2 illustrates a kiosk, a stand-alone unit, or a communication device adapted to read the digital image storage medium in accordance with the present invention; and

FIG. 3 illustrates a mini-lab adapted to process images from a digital image storage medium having a label in accordance with the present invention.

### DETAILED DESCRIPTION OF THE INVENTION

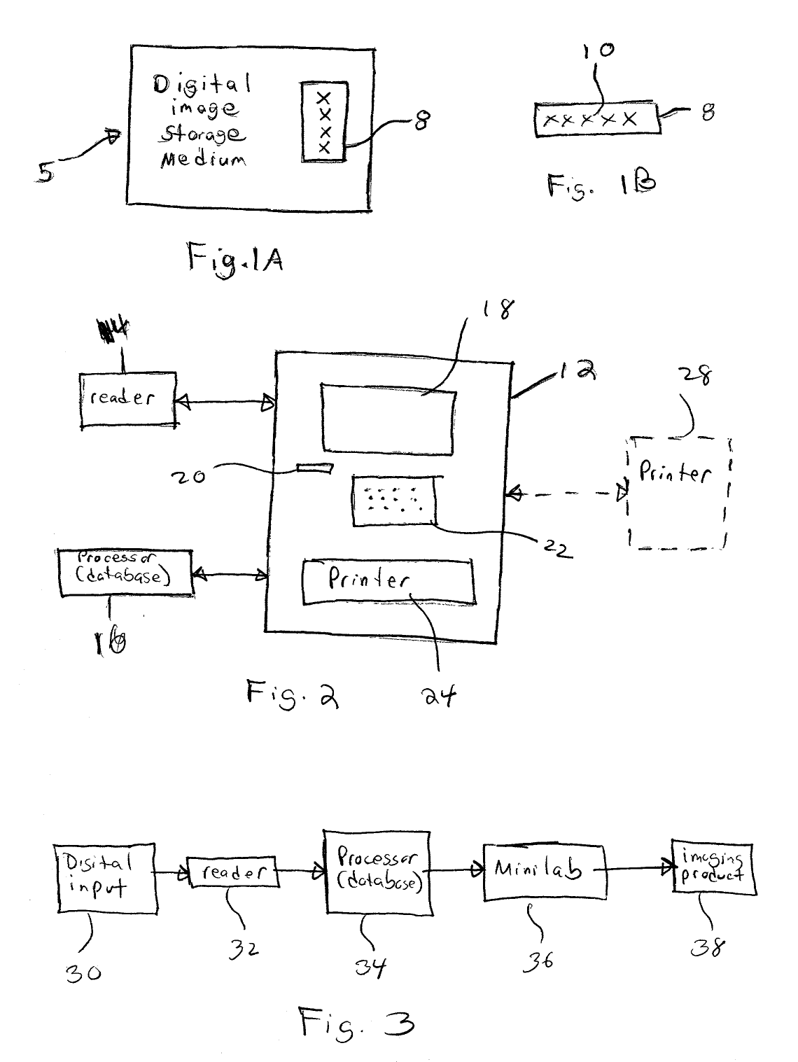

Referring now to the drawings, wherein like reference numerals represent identical or corresponding parts throughout the several views, FIG. 1A schematically illustrates an encoded removable and reusable digital image storage medium 5, such as a memory card, a compact flash card, a floppy disk, a secure digital media card (SD memory), a memory stick, a hard drive, an optical disk, etc. Encoded digital image storage medium 5 has a label 8 affixed thereon. Label 8 is preferably an adhesive label of negligible thickness to allow digital image storage medium 5 to be used in a camera or any other device that incorporates digital image storage medium 5.

As illustrated in FIG. 1B, label 8 preferably includes encoded information 10 thereon. Encoded information 10 is preferably provided on label 8 by a service provider and could be in the form of, for example, a simple bar code, a RF (Radio Frequency) identification tag, a magnetic strip, or some form of human readable letters, numbers or symbols. As noted above, label 8 is preferably an adhesive label that could be easily affixed to digital image storage medium 5 and is of negligible thickness to allow digital image storage medium 5 to be used in a camera or any other device the incorporates a removable memory.

Encoded information 10 is preferably information that would provide a link to a database in a processor or processing unit when encoded information 10 is read by a reader of an imaging device. The further information in the database that is linked to encoded information 10 could be identified as stored label information and could include information such as customer billing or personal information, and information on photofinishing services which are to be provided to the images that are loaded from the digital image storage medium to an imaging device.

As will be described later, the information with respect to photofinishing services could be defined in the following manner. The customer can set up the information to include (unless otherwise noted) at least a default customer profile. The default customer profile would comprise a default photofinishing service that would be provided to the customer every time the customer supplies the digital image storage medium, such as a memory card, with a label attached thereto to an imaging unit such as a kiosk. The default photofinishing service is preferably a service which is preferred by the customer. Since the information would also include billing information, when a customer uses a digital image storage medium with a label thereon in accordance with the present invention, and desires his/her default photofinishing services, the customer would only have to insert his/her digital image storage medium into the kiosk. There would be no need for the customer to enter information or interact in anyway with the kiosk other than loading the digital image storage medium, removing the digital image storage medium and (a) picking up his/her prints if the kiosk includes a printer, (b) having the prints delivered (if part of the default preferred processing service) or (c) picking the prints up at a later time.

Therefore, in a preferred feature of the present invention, encoded information 10 would provide a link to a stored database of label information which would include the customer's billing information and profile, and would also include default information with respect to the customer's preferred photofinishing services as noted above. More specifically, the default information would include information on the preferred photofinishing services desired by the customer for images that are loaded from encoded digital image storage medium 5. With the system of the present invention, every time a customer places an encoded removable digital image storage medium 5 into an imaging station having a reader (such as a kiosk), the reader would read encoded information 10, link up with the stored database information, and if the default customer profile is active, the photofinishing service provider will automatically provide the customer with the required photofinishing services on the images loaded from digital image storage medium 5. With this arrangement, there would not have to be any operator or customer intervention at the point where the customer inserts digital image storage medium 5 having label 8 thereon into, for example, a kiosk or the front end of a mini-lab.

As an example, if the default customer profile in the stored database that is linked to encoded information 10 on label 8 indicates that the customer prefers 4 by 6 double prints of the images on removable digital image storage medium 5 (such as a memory card, etc.), every time the customer submits the memory card with an encoded label to, for example, a kiosk, the customer billing information as well as the custom profile will be read from the encoded information. Without any intervention from the customer or an operator, the customer will automatically have an order input that indicates that he or she wants 4×6 double prints of the images that are loaded from the memory card to the kiosk. Further, the customer billing information will also appear on the encoded information. Thus, the customer will not have to interact with or enter any information into the kiosk.

As a further option, in addition to the default customer profile that indicates that, for example, the customer prefers 4×6 double prints, the customer can enter additional or secondary customer profiles that would provide the customer with the flexibility to order different products. For example, a secondary customer profile could indicate that in addition to 4×6 double prints, the customer wants a photo CD. In that scenario, the interface of the kiosk could basically be designed to let the customer push a button or enter a number that specifies that the secondary profile is the active profile for the images on the memory card. More specifically, encoded information 10 could include a default profile and, for example, a plurality of other profiles set in order of the customer preference or frequency of use. If no intervention or interaction is done by the customer at the time of loading his/her images into the imaging device, the system will automatically know that the customer prefers the default profile and accordingly, will provide the customer with, for example, 4×6 double prints if that is the default profile. If the customer enters a first number or somehow identifies that he/she wants photofinishing services not covered by the default profile, the customer can identify a profile other than the default profile, to permit the customer to order services outside of the default profile, such as a photo CD, or an image product such as a coffee mug, T-shirt, a photo album, greeting cards, post cards, etc.

However, by having a default customer profile, when the customer desires photofinishing services in accordance with the default profile, no operator or customer intervention is required when the customer supplies his/her images to an imaging device. The imaging device, such as a kiosk equipped with a reader, would read the encoded information on the memory card, and will automatically know what photofinishing services are to be provided for the images from the memory card, and at the same time, the encoded information will provide a link to the customer billing information for billing purposes. Of course, if a memory card without a label thereon is provided to the kiosk, the order would be fulfilled in accordance with the customer's specified instructions resulting from the interaction between the customer and the kiosk or operator.

As a further option, encoded information 10 and label 8 can enable the service provider to transparently link the customer into an affinity (loyalty membership) relationship group to provide advantaged services and pricing to identified members.

FIG. 2 schematically illustrates an example of a kiosk, or a communication device which can be enabled to be utilized within the context of the present invention. As shown in FIG. 2, kiosk 12 preferably includes a screen 18 which enables the customer to view instructions and his/her images, as well as a keyboard, or other input device 22 which can be used when necessary to control features of the kiosk and/or enter information. Kiosk 12 further includes an input section 20 for a digital image storage medium such as a memory card, a reader 14 which is adapted to read encoded information 10 on label 8 that is affixed to digital image storage medium 5, and a processor 16 that includes a database.

During use of kiosk 12, a customer having a digital image storage medium 5 with a label 8 thereon as shown in FIG. 1A would enter digital image storage medium 5 into input section 20. Upon submitting digital image storage medium 5, reader 14 will read encoded information 10 on label 8 before, during or after the images are loaded from digital image storage medium 5 to kiosk 12. Upon reading encoded information 10, processor 16 having a database will automatically link encoded information 10 with label information stored in processor or database 16. The stored label information is associated with the customer and his/her digital image storage medium 5 and includes, but is not limited to, customer information such as customer billing information, a customer default profile, a customer preferred default photofinishing service, and optionally secondary services or profiles selected by the customer. If the customer providing encoded digital image storage medium 5 does not enter any input at keyboard 22, reader 14 as well as processor 16 will know that the customer prefers the default customer profile and accordingly, will provide photofinishing services to images loaded from digital image storage medium 5 in accordance with the customer's default profile.

Kiosk 12 could be provided with a photofinishing services output section such as a local printer or a remote printer to print the images in accordance with the customer's default profile. For example, kiosk 12 could include a printer 24 to provide prints to the customer if that is the imaging product desired, or can be connected via an internet connection or some other line to a remote printer 28. As a further option, kiosk 12 can communicate with a service provider who will fulfill the order and provide the appropriate prints or imaging product for pickup or delivery. Of course, the present invention is not limited to a kiosk as an imaging station or device. Reference numeral 12 can represent a communication device, a printer or a camera adapted to provide imaging services.

With the system of the present invention, a service provider or business would supply labels 8 and optionally a digital image storage medium such as memory cards to the customer, and would also provide encoded information 10 on label 8. At the same time, the service provider would enter further or detailed information associated with the customer, the encoded information, the default customer profile, and optionally secondary customer profiles into the processor or database. Encoded information 10 would thereafter be linked to the processor database every time label 8 on digital image storage medium 5 is read at, for example, a reader of a kiosk or some other reading device. The service provider could provide the customer with a roll of adhesive labels with instructions on where labels 8 are to be provided on digital image storage medium 5 with respect to an affixing location, or can create labels 8 and affix them to digital image storage medium 5 themselves and thereafter, provide the removable digital image storage medium to the customer. As noted above, labels 8 are preferably adhesive labels which are of negligible thickness to allow the digital image storage medium, such as a memory card, to be used in a camera and at the same time, allow the digital image storage medium to be inserted into an imaging device such as a kiosk.

FIG. 3 illustrates a further embodiment regarding the use of the digital image storage medium and system in accordance with the present invention. FIG. 3 schematically illustrates a minilab environment which includes a digital input. Thus, in the embodiment of FIG. 3, a user would provide an encoded digital image storage medium such as a memory card to a front end of a minilab 36 which includes an input port 30. Minilab 36 would also include a reader 32 which would read encoded information 10 on label 8 provided on digital image storage medium 5. Encoded information 10 when read would enable a link to a database or processor 34. Processor 34 includes the database of stored information which is linked to the encoded information read by reader 32. Processor 32 supplies this information to a control system of minilab 36 which would provide photofinishing services to the images from digital image storage medium 5 in accordance with the linked information. More specifically, if the customer does not provide any input to the minilab other than loading the encoded digital image storage medium 5, a default customer profile would be enabled which would provide the customer with preferred default photofinishing services on images in removable digital image storage medium 5. At the same time, encoded information 10 would include customer billing information so as facilitate the billing process. If a secondary profile or other profile is utilized, the linked database would automatically provide the customer with services in accordance with the information in the secondary profile. The images are processed in minilab 36 in accordance with the customer requirements, and imaging products 38 in the form of, for example prints, are supplied to the customer.

Therefore, the present invention provides for a novel system and method for affixing customer information to a removable digital image storage medium such as a memory card, a compact flash card, a floppy disk, a SD memory, a memory stick, a hard drive, an optical disk, etc., to facilitate value added photofinishing processes. The customer information is encoded onto an adhesive label that is easily affixed to the individual digital image storage medium. The label could include a simple bar code, could incorporate an RF information tag, could include a magnetic strip or could include some form of human readable information. In the present invention, it is preferable that the label be of a thickness that permits the digital image storage medium to be utilized in a camera or some other kind of device. With the arrangement of the present invention, the photofinishing services provided to the customer and a bill for the photofinishing service, can be generated by the customer information.

In a preferred feature of the present invention, a customer would sign up with a service provider or a photofinisher as a specified member. An adhesive label with an already printed bar code would then be affixed to, for example, the customer's memory card or a memory card supplied by the service provider. Also, the service provider would enter the label number into a host database system. At that point, a significant amount of photofinishing customization and billing information could be linked to the memory card through the information stored on the host database. After that, every time a customer placed their encoded memory card into a reader at a photofinishing counter, for example, the front end of a minilab or a kiosk, the encoded information would be read while the image files were being off loaded from the card. The customer information would then be linked back through the database system and all the necessary billing and customization information added to the order, without any operator or customer intervention.

The present invention facilitates the photofinishing process by automatically and transparently assigning customer billing and customization data such as encoded information, customer preferences and profiles to a customer digital order. With the system and method of the present invention, there is no need to alter the file structures or the architecture/ electronics on a digital image storage medium, such as a memory card, since the adhesive label is provided on the digital image storage medium. In a preferred feature of the present invention, the adhesive label is permanently provided on the digital image storage medium so that the digital image storage medium can be continuously used and thus, the customer profile in the encoded information on the digital image storage medium is associated with all present and future images stored on the particular digital image storage medium. Further, the reader of the present invention, whether in a kiosk or minilab environment, can be an off-the-shelf item and readily fit into an area where a digital image storage medium such as a memory card is inserted into a kiosk or front end of a minilab to load images.

As a still further feature of the present invention, part of the encoded information can include a link to a URL to instruct the service provider to get pictures from a further location or instruct the service provider to send the images via the internet back to the customer.

The present invention is also not limited to an adhesive label as described. It is recognized that label 8 having encoded information 10 thereon could be an integral part of digital image storage medium 5. More specifically, the labeling which includes the encoded information function can be molded or incorporated into the body of digital image storage medium 5. The encoded information can also be an embedded RF Tag printed on the body of digital image storage medium 5, molded into the body of digital image storage medium 5, etc.

The invention has been described in detail with particular reference to certain preferred embodiments thereof, but it will be understood that variations and modifications can be effected within the spirit and scope of the invention.

What is claimed is:

1. A method of offering imaging services to a customer, the method comprising the steps of:
providing a label having encoded information thereon to a customer, said label being adapted to be affixed onto a removable digital image storage medium, said encoded information being associated with the customer;
entering label information representative of the encoded information into a database to store the label information;
reading the encoded information on the label when the customer places a removable digital image storage medium with the label affixed thereon into an imaging station having a reader, the images on the digital image storage medium being loaded from the digital image storage medium to the imaging station;
linking the encoded information on the label of the digital image storage medium with the stored label information in the database; and
providing imaging services to images loaded to the imaging station from the digital image storage medium based on at least the linked stored label information in the database.

2. A method according to claim 1, wherein the stored label information includes customer billing information and information on photofinishing services which are to be provided to the images that are loaded from the digital image storage medium to the imaging station, such that the photofinishing services provided to the customer and a bill for the photofinishing services provided to the customer are generated by the stored label information.

3. A method according to claim 1, wherein the encoded information on the label is at least one of a bar code, a RF identification tag, a magnetic strip or human readable information.

4. A method according to claim 1, wherein said imaging station is a kiosk.

5. A method according to claim 1, wherein said imaging station includes a minilab.

6. A method according to claim 1, wherein the stored label information includes customer billing information and a customer profile which comprises at least a default customer preference for desired photofinishing services which are to be performed on all images which are loaded from the memory card.

7. A method according to claim 1, wherein said removable digital image storage medium is a memory card, a compact flash card, a floppy disk, a secure digital media card, a memory stick, a hard drive or an optical disk.

8. A method according to claim 1, wherein said imaging station is a communication device used to provide imaging services.

9. A method according to claim 1, wherein said imaging station is a printer used to provide imaging services.

10. A method according to claim 1, wherein said imaging station is a camera.

11. A method of offering photofinishing imaging services to a customer, the method comprising the steps of:
encoding customer information onto at least one adhesive label;
entering label information representative of the encoded customer information into a database to store the label information;
affixing the adhesive label onto a removable digital image storage medium and providing the digital image storage medium to a customer;
reading the encoded customer information on the adhesive label when the customer submits the digital image storage medium with images thereon to a reader of an imaging station, said encoded customer information being read by the reader as the images on the digital image storage medium are being loaded into the imaging station;
linking the encoded customer information on the label of the digital image storage medium with the stored label information in the database; and
providing imaging services for images on the digital image storage medium based on at least the linked stored label information in the database.

12. A method according to claim 11, wherein the stored label information includes at least billing information for the customer.

13. A method according to claim 11, wherein the stored label information includes at least information on photofinishing services which are to be provided to the images which are loaded from the digital image storage medium to the imaging station.

14. A method according to claim 11, wherein the stored label information includes at least information on default photofinishing services preferred by the customer for images that are loaded from the digital image storage medium to the imaging station.

15. A method according to claim 11, wherein the stored label information includes information on photofinishing services which are to be provided to the images which are loaded from the digital image storage medium to the imaging station and customer billing information.

16. A method according to claim 11, wherein the encoded customer information on the label is at least one of a bar code, a RF identification tag, a magnetic strip or human readable information.

17. A method according to claim 11, wherein said imaging station is a kiosk.

18. A method according to claim 11, wherein said imaging station includes a minilab.

19. A method according to claim 13, wherein said photofinishing services includes at least one of creating photographic prints, a photo CD, a coffee mug or a T-shirt based on the images.

20. A method according to claim 11, wherein said removable digital image storage medium is a memory card, a compact flash card, a floppy disk, a secure digital media card, a memory stick, a hard drive, or an optical disk.

21. A method according to claim 11, wherein the stored label information includes a linkage to a customer affinity/loyalty/membership relationship.

22. A system for offering imaging services, the system comprising:
an input section adapted to receive a removable digital image storage medium therein and permit a loading of images from the digital image storage medium;
a reader adapted to read a label on the digital image storage medium, said label having encoded information thereon and being affixed onto the digital image storage medium, said encoded information being associated with a customer; a processor having a database for storing label information representative of the encoded information, said processor being adapted to link the encoded information which is read by the reader from the label with the stored label information; and
a photofinishing services output section adapted to provide imaging services to the images on the digital storage medium based on at least the linked stored label information in the database.

23. A system according to claim 22, wherein said removable digital image storage medium is a memory card, a compact flash card, a floppy disk, a secure digital media card, a memory stick, a hard drive, or an optical disk.

24. A system according to claim 22, wherein said label is an adhesive label.

25. A system according to claim 22, wherein said input section, said reader, and said processor are at least a part of a kiosk.

26. A system according to claim 25, wherein said photofinishing services output section is a printer in the kiosk.

27. An imaging services arrangement according to claim 25, wherein said photofinishing services output section is a remote printer.

28. A system according to claim 22, wherein said input section, said reader and said processor are at least part of a minilab.

29. A system according to claim 22, wherein the stored label information includes customer billing information and information on photofinishing services which are to be provided to the images that are loaded from the digital image storage medium, such that the photofinishing services provided to the customer and a bill for the photofinishing services provided to the customer are generated by the stored label information.

30. A system according to claim 22, wherein the stored label information includes customer billing information and a customer profile which comprises a default customer preference for desired photofinishing services which are to be performed on all images which are loaded from the digital image storage medium.

31. A system to claim 22, wherein the encoded information on the label is at least one of a bar code, a RF identification tag, a magnetic strip or human readable information.

32. A method of offering photofinishing imaging services to a customer, the method comprising the steps of encoding customer information onto a digital image storage medium;
entering further information representative of the encoded customer information into a database to store the further information;
reading the encoded customer information on the digital image storage medium when the customer submits the digital image storage medium with images thereon to a reader of an imaging station;
linking the encoded customer information on the digital image storage medium with the stored further information in the database; and
providing imaging services for images on the digital image storage medium based on at least the linked stored further information in the database.

33. A method according to claim 32, wherein the stored further information includes at least billing information for the customer.

34. A method according to claim 32, wherein the stored further information includes at least information on photofinishing services which are to be provided to the images which are loaded from the digital image storage medium to the imaging station.

35. A method according to claim 32, wherein the stored further information includes at least information on default photofinishing services preferred by the customer for images that are loaded from the digital image storage medium to the imaging station.

36. A method according to claim 32, wherein the stored further information includes information on photofinishing services which are to be provided to the images which are loaded from the digital image storage medium to the imaging station and customer billing information.

37. A method according to claim 32, wherein the encoded customer information is integral with said digital image storage medium.

38. A method according to claim 32, wherein said storage medium is a memory card, a compact flash card, a floppy disk, a secure digital media card, a memory stick, a hard drive or an optical disk.
